(19) United States
(12) Patent Application Publication
(10) Pub. No.: US 2025/0162795 A1
(43) Pub. Date: May 22, 2025

(54) WASTE COMPACTOR

(71) Applicant: FAST AUTOMATION PTY LTD, Macquarie Park, New South Wales (AU)

(72) Inventor: David ASKEW, Putney, New South Wales (AU)

(21) Appl. No.: 18/840,558

(22) PCT Filed: Feb. 13, 2023
(86) PCT No.: PCT/AU2023/050095

§ 371 Date: Aug. 22, 2024

(30) Foreign Application Priority Data
Feb. 24, 2022 (AU) 2022900437

(51) Int. Cl. B65F 1/14

(52) U.S. Cl. CPC B65F 1/1405; B65F 2210/162

(57) ABSTRACT

An assembly for compacting waste materials stored within a receptacle. The assembly comprises a frame to which a compacting arm attached. The compacting arm is able to pivot relative to the frame whereby the compacting arm is able to compact the waste materials located in the receptacle by moving between an unextended configuration and an extended configuration.

### TECHNICAL FIELD

This disclosure relates generally to a system and method for waste compaction, and in particular, to a system and method for compaction of waste materials within wheelie bins.

### BACKGROUND

Compaction of waste is one known method of reducing the number of times a waste receptacle, such as domestic or commercial wheelie bins or waste skips, needs to be emptied. Particularly for high-volume waste producers, compacting the waste or rubbish can be an effective method of reducing the costs associated with disposing of the waste. A variety of waste compaction solutions are thus available to assist with the waste management process.

The compacting plate of some known waste compactors are designed to have a similar diameter or surface area as the inlet of the bin where the waste is held. Thus, in order to add additional waste material into the bin during a compaction process, the bin is removed from the waste compactor so as to remove the obstruction of the compacting plate and allow for additional waste material to be deposited into the bin. However, this process of inserting and removing the bin between compactions can be time-consuming, and thereby may reduce the efficiency gains desired from the waste compactor.

In some alternative solutions, the actuating arm can be autonomously lifted and moved away from the inlet of the bin. However, these automated systems are often excessively large in physical size and cost of implementation, thereby rendering them impractical and unsuitable, particularly for domestic waste management.

Additionally, waste compactors are expected to exert a downward force to compact waste materials of a large variety of shapes, sizes, materials, and densities. This may result in some materials, for example rigid slender materials, avoiding compaction should they be arranged in an unfavourable orientation within the bin. Alternatively, some waste materials may react adversely to compaction. For example, the compaction can generate a build-up of potential energy which may result in an undesirable release of kinetic energy if disturbed.

There may be a need for a waste compaction solution suitable for domestic use that remediates, or alleviates at least in part, some or all of the shortcomings outlined above.

### SUMMARY OF THE DISCLOSURE

In a first aspect, embodiments are disclosed of an assembly for compacting waste materials stored within a receptacle. The assembly comprises a frame to which a compacting arm attached. The compacting arm is able to pivot relative to the frame whereby the compacting arm is able to compact the waste materials located in the receptacle by moving between an unextended configuration and an extended configuration. The disclosed assembly may provide an inexpensive solution that overcomes, at least partially, some or all of the shortcomings outlined above.

The pivoting of the compacting arm may enable a user to remove the arm from obstructing access to the receptacle. This may provide a more cost efficient assembly that improves the efficiency with which the interior of the receptacle is accessed between compacting operations whilst mounted within the disclosed assembly. This may allow a user to easily add further materials to the receptacle, or re-arrange oddly oriented objects therein to improve effectiveness of the compacting therein.

In some embodiments, the compacting arm may retract from the extended configuration to the unextended configuration. In some embodiments, the compacting arm may be able to extend and/or retract to a configuration that is intermediate the unextended and extended configurations.

In some embodiments, the compacting arm may pivot about a hinge attached to the frame, the compacting arm being orientated below a support on the frame. In some embodiments, the compacting arm may be able to pivot rearward of the support, away from an expected standing position of an operator.

In some embodiments, the receptacle may be supported on one or more flanges provided on one or more sides of the frame. In some embodiments, the frame may comprise an upper portion and a lower portion, the lower portion providing a base for the assembly and defining a cage that is configured to receive and retain the receptacle in use, and the upper portion being supported over the lower portion with the compacting arm extending downwardly from the support so as to locate over the receptacle in use. In some embodiments, the one or more flanges may extend horizontally, and parallel to one another, along opposing sides of the lower portion of the frame. In some embodiments, the receptacle may be held in an elevated position above the ground surface by the one or more flanges.

In some embodiments, the lower portion may have an opening through which the receptacle can be passed so as to located therein or be removed therefrom. In some embodiments, a locking bar may be removably configurable across the opening, the locking bar preventing the removal of the receptacle in use.

In some embodiments, the support may locate, at least in part, forward of a central axis of the frame.

In some embodiments, the compacting arm may comprise a linear actuator that operates to controllably adjust the extension thereof. In some embodiments, the compacting arm may comprise a compacting plate at an in-use lower distal end thereof. In some embodiments, one or more edges around the perimeter of the compacting plate may be bevelled, chamfered, or rounded.

In some embodiments, the compacting arm may comprise a handle. The handle may enable a user to more easily grip the compacting arm of the disclosed assembly, whilst the freely moving hinge provides the user with an additional method to adjust the orientation of materials within the waste receptacle. The user may pull and push the compacting plate to shake these materials into a more favourable orientation. Together, the disclosed features of the assembly may have an effect where horizontal forces of material compacting are largely resisted by the person operating the device. Therefore, the structural members of the device experience a decreased load, permitting inexpensive material options.

In some embodiments, the assembly may comprise one or more buttons that communicate with a control system that controls the operation of the compacting arm. In some embodiments, the one or more buttons may be arranged on the compacting arm. In some embodiments, the receptacle may be a wheelie bin.

In a second aspect, embodiments are disclosed of a method of compacting waste materials in an assembly for compacting waste stored within a receptacle, the method comprising locating the receptacle below a compacting arm, the compacting arm being attached to a frame, and able to pivot relative to the frame; moving the compacting arm between an unextended configuration and an extended configuration; and compacting the waste materials between the compacting arm and the receptacle.

In some embodiments, the method may further comprise retracting the compacting arm from the extended configuration to the unextended configuration. In some embodiments, the method further may comprise extending and/or retracting the compacting arm to a configuration that is intermediate the unextended and extended configurations.

In some embodiments, the compacting arm may pivot about a hinge, the hinge being attached to the frame, the compacting arm being orientated below a support on the frame. In some embodiments, the compacting arm may be able to pivot rearward of the support and away from an expected standing position of an operator. In some embodiments, the compacting arm may comprise a handle.

In some embodiments, the assembly may comprise one or more buttons that communicate with a control system that controls the initiation and/or a cessation of operation of the compacting arm. In some embodiments, the one or more buttons may be arranged on the compacting arm.

In some embodiments, the receptacle may be supported on one or more flanges provided on one or more sides of the frame. In some embodiments, the frame may comprise an upper portion and a lower portion, the lower portion providing a base for the assembly and defining a cage that is configured to receive and retain the receptacle in use, and the upper portion being supported over the lower portion with the compacting arm extending downwardly from the support so as to locate over the receptacle in use. In some embodiments, the one or more flanges may extend horizontally, and parallel to one another, along opposing sides of the lower portion of the frame. In some embodiments, the receptacle may be held in an elevated position above the ground surface by the one or more flanges. In some embodiments, the support may locate, at least in part, forwardly of a central axis of the frame.

In some embodiments, the lower portion may have an opening through which the receptacle can be passed so as to located therein or be removed therefrom. In some embodiments, the method may further comprise after the locating step, pivotally configuring a removable locking bar across the opening such that the locking bar prevents the removal of the receptacle.

In some embodiments, the compacting arm may comprise a linear actuator that operates to controllably adjust the extension thereof. In some embodiments, the compacting arm may comprise a compacting plate at an in-use lower distal end thereof, the compacting plate being adapted to engage and compact the waste materials within the receptacle. In some embodiments, one or more edges around the perimeter of the compacting plate may be bevelled, chamfered, or rounded.

In some embodiments, the receptacle may be a wheelie bin.

Other aspects, features, and advantages will become apparent from the following detailed description when taken in conjunction with the accompanying drawings, which are a part of this disclosure and which illustrate, by way of example, principles of inventions disclosed.

### DESCRIPTION OF THE FIGURES

The accompanying drawings facilitate an understanding of the various embodiments. The invention will now be described, by way of non-limiting example only, with reference to the accompanying drawings, in which:

FIGS. 1A to 1E are an anterior projection, side, plan, back and front view, respectively, of a first embodiment of the waste compactor.

FIGS. 2A to 2E are an anterior projection, side, plan, back and front view, respectively, of the waste compactor of FIG. 1, with a first embodiment of a wheelie bin located therein.

FIGS. 3A to 3C are side views through a first central plane X-X of an untilted embodiment of the waste compactor in an unextended configuration, intermediate partially extended configuration, and fully extended configuration, respectively.

FIGS. 4A to 4C are side views through a first central plane X-X of an embodiment of the waste compactor in an unextended configuration tilted at 40°, intermediate partially extended configuration tilted at 4.2°, and fully extended configuration tilted at 3°, respectively.

FIG. 5 is an anterior projection view of FIG. 3C.

### DETAILED DESCRIPTION

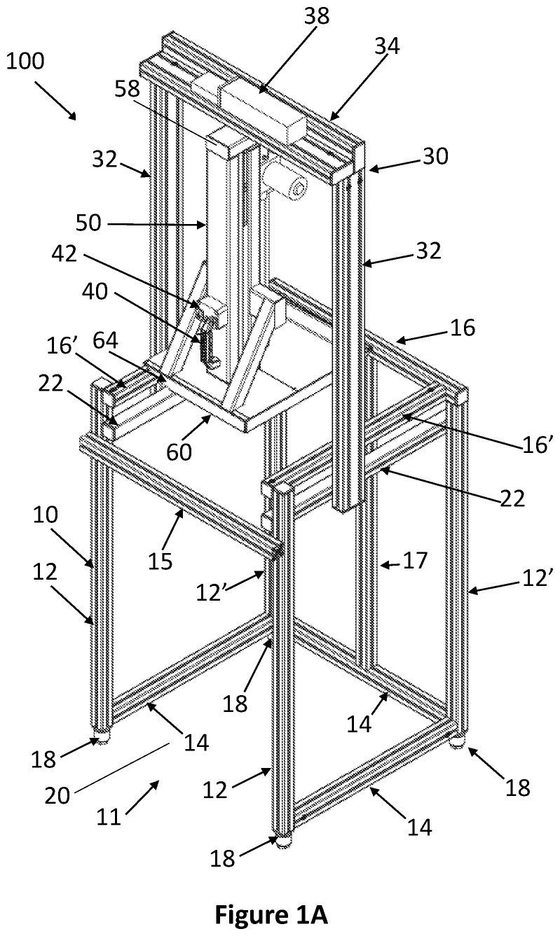

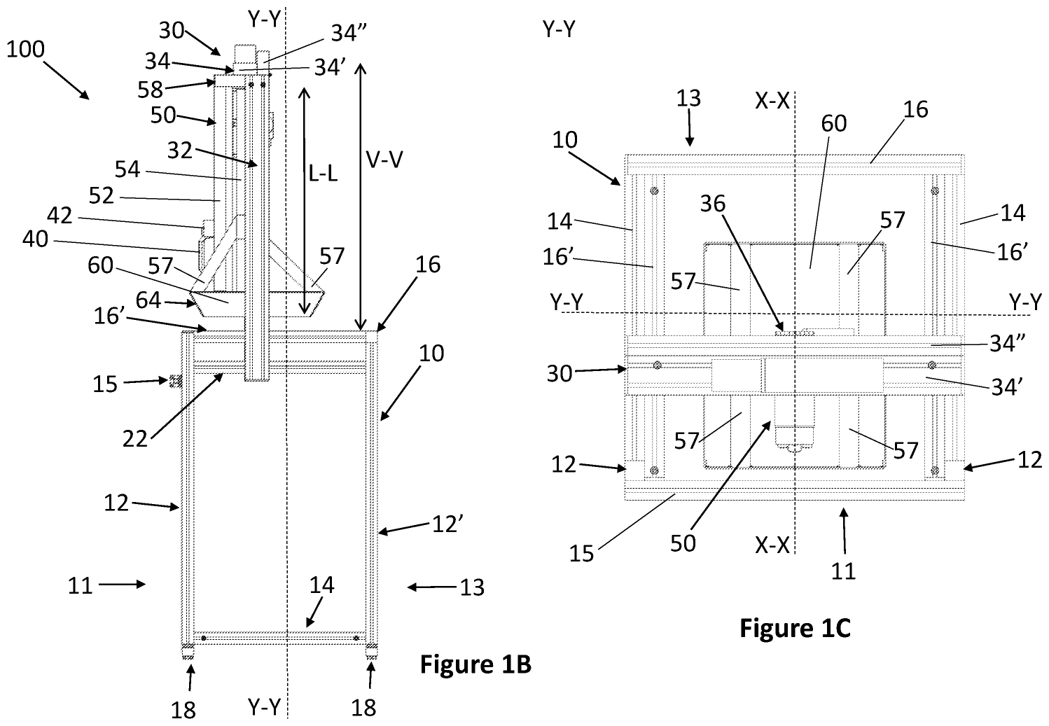

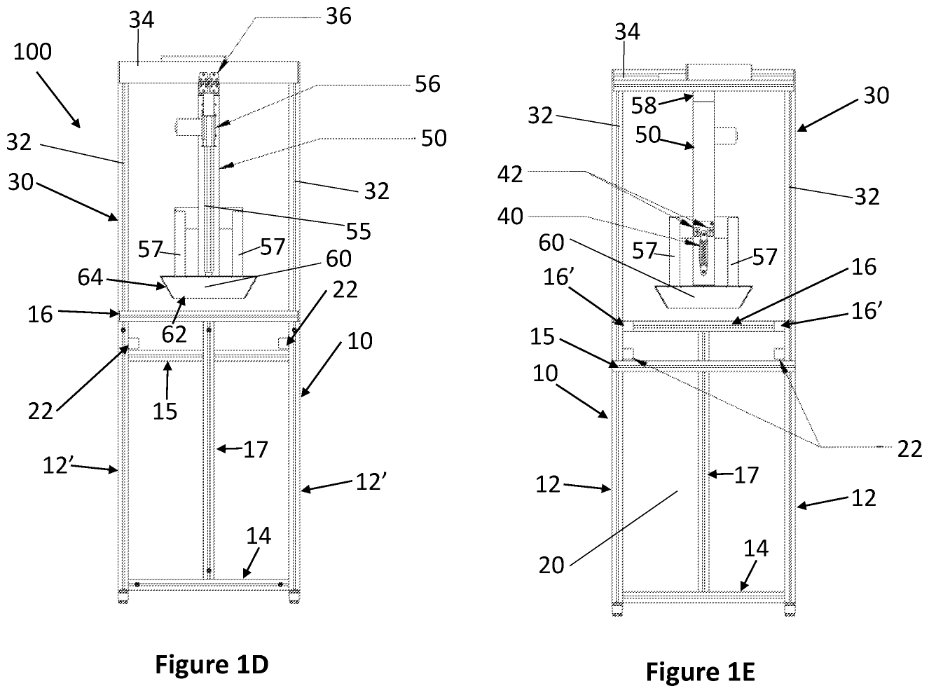

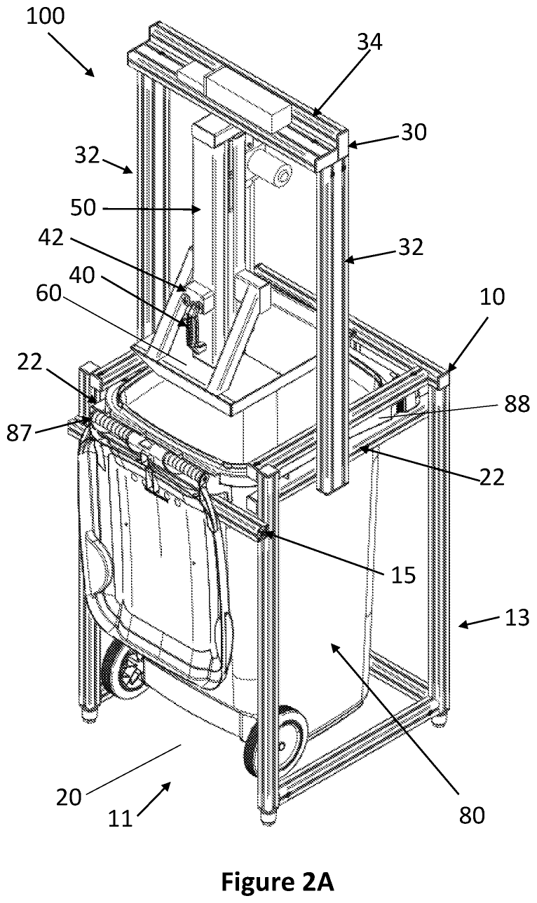

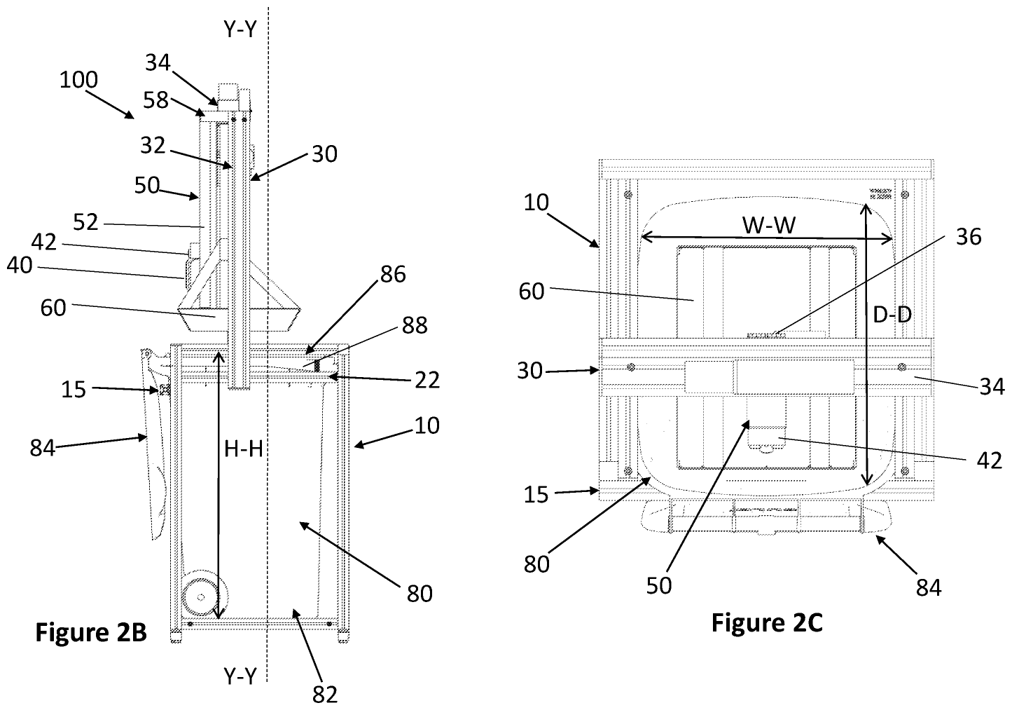

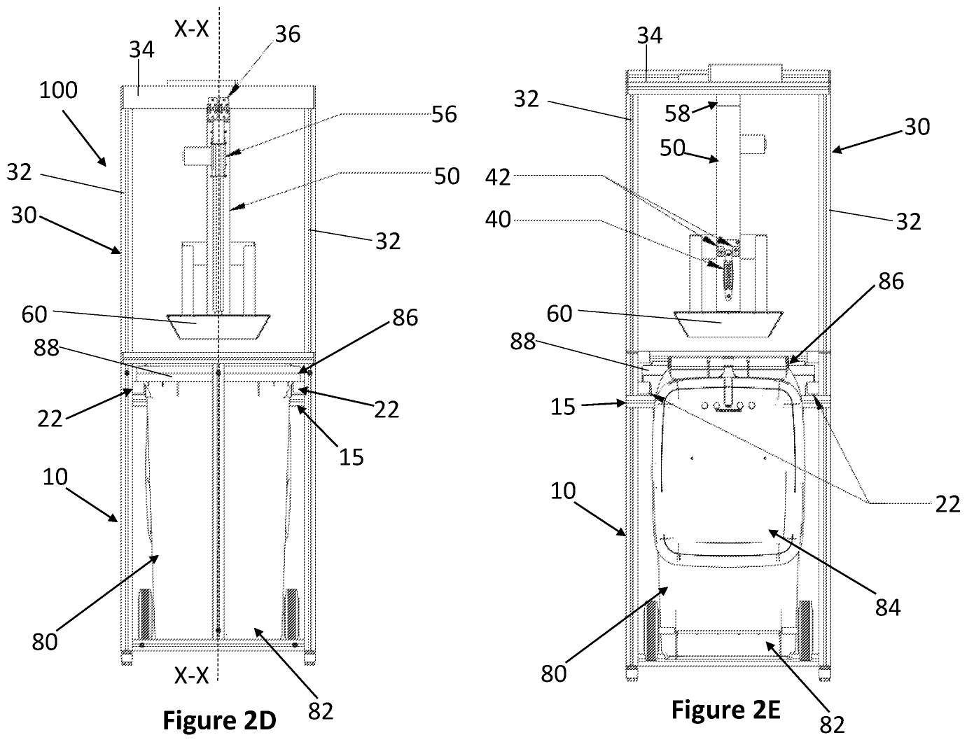

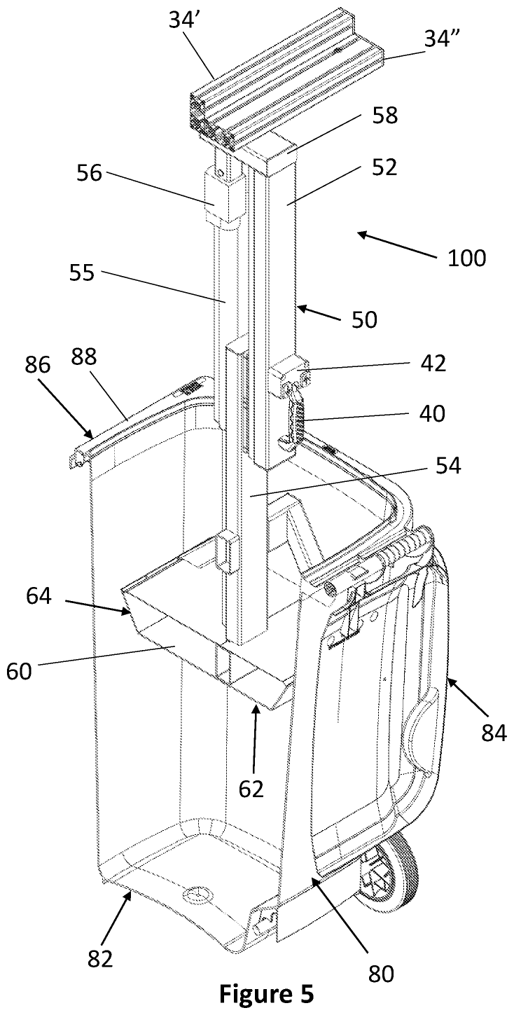

Referring to FIGS. 1 to 5, an embodiment of a waste compactor 100 that is suitable for compacting waste materials that have been deposited within domestic or commercial waste receptacles. Where like reference numerals are used in the following description, the features are considered to be the same unless specified as being otherwise.

For the purposes of this disclosure, a waste compactor is described that is compatible with a 2 wheel wheelie bin 80, the wheelie bin 80 having a substantially square cross-section that becomes wider in width W-W and depth D-D as the height H-H elevates from the base 82 to the upper rim 86 of the wheelie bin 80. As would be readily understood by one skilled in the art, a large number of variations are possible for waste receptacles that may be suitable for use with a waste compactor in accordance with the present disclosure. For example, suitable waste receptacles can include, but are not limited to, plastic or metal rubbish bins. The waste receptacles can be supported on two wheels or four wheels, or have no wheels at all. The waste receptacles can be substantially square, rectangular, cylindrical in cross-section, or have any other suitable combination of shape and dimensions, as required, with a unifying feature being an aperture at an in-use upper surface of the waste receptacle through which the waste compactor can access and compact the waste contained within the waste receptacle.

The in-use lower portion of the waste compactor 100 defines a cage 10 having a framework that is shaped and sized to receive the waste receptacle within an interior cavity defined therein (e.g. a wheelie bin 80) through an opening 20 provided through an in-use forward side 11 of the cage 10. The cage 10 comprises a plurality of vertically upright posts 12 that are spaced at each of the corners of the cage 10. A foot 18 extends downwardly from the bottom of each of the corner posts 12,12′, supporting the base of the waste compactor 100 above the ground surface. In some forms where the ground surface is undulated, slanted or generally uneven, the height of each foot 18 can be adjusted in order to evenly support and balance the waste compactor 100. The two corner posts 12′ at the in-use rearward side 13 of the cage 10 are connected by an upper cross-bar 16 that is mounted to the top surface of the two corner posts 12′. The in-use rearward two corner posts 12′ are shorter than the in-use forward two corner posts 12 by the height of the upper cross-bar 16, such that the top surface of the in-use forward two corner posts 12 and the upper cross-bar 16, respectively, are coplanar. The in-use forward two corner posts 12 are connected to the in-use rearward two corner posts 12′ by a lower cross-bar 14 that is secured between their respective lower ends. A further lower cross-bar 14 extends across between the lower ends of each of the two in-use rearward corner posts 12′. Each of the lower cross-bars 14 are connected to the opposing facing surfaces of each pair of corner posts 12,12′. The lower cross-bars 14 therefore do not protrude from the framework of the cage 10 into the interior of the cage 10, and thus do not engage or interact with the body of the waste receptacle 80. A further upright 17 extends from above the rear lower cross-bar 14 to the upper cross-bar 16, the further upright 17 being centrally located between the two in-use rearward two corner posts 12′. The further upright provides additional structural support to the rearward portion of the cage 10.

A pair of side upper cross-bars 16′ are arranged on either side of the cage 10, extending from the rearward upper cross-bar 16 to the in-use forward two corner posts 12. The side upper cross-bars 16′ are inwardly offset from the sides of the cage 10, as defined by the plane formed across the corner posts 12,12′, with an outwardly facing side surface proximal the forward end of each of the side upper cross-bars 16′ being secured to the inner facing surface of the in-use forward two corner posts 12 proximal to the top end thereof. Similarly, the rearward end of each of the side upper cross-bars 16′ are secured to the rearward upper cross-bar 16 inset from the opposing distal ends thereof, and with the top surface of the side upper cross-bars 16′ being coplanar with the top surface of the upper cross-bar 16 such that each of the side upper cross-bars 16′ extend parallel to one another.

A pair of substantially horizontally extending flange supports 22 are arranged on either side of the cage 10, parallel to and spaced below the pair of side upper cross-bars 16′. The flange supports 22 are thus inwardly offset from the sides of the cage 10, and are each secured to the inner facing surfaces of an adjacent in-use forward corner post 12 and an in-use rearward corner post 12′ at a height that is intermediate the height of the lower cross-bars 14 and the side upper cross-bars 16′. The spacing between a flange support 22 and the side upper cross-bar 16′ thereabove can be configured to closely conform to, or correspond to, the thickness of the ribbed flange 88 of wheelie bin 80 waste receptacle, whereby the flange supports 22 act to guide the waste receptacle into the interior cavity of the cage 10 such that the ribbed flange 88 rests on the flange supports 22 and the waste receptacle is supported in the desired position beneath the actuating arm 50 of the waste compactor 100. In some forms, not shown, the spacing of the flange supports relative to the side upper cross-bars 16′ can be adjustable.

A locking bar 15 that is pivotally extendable across the opening 20 between the in-use forward two corner posts 12 can assist with securing the position of the waste receptacle within the cage 10. The locking bar 15 is pivotally secured at a first end to an outer facing surface of a first of the in-use forward corner posts 12. In use, in order to allow a waste receptacle into the interior cavity of the cage 10, the locking bar 15 is positioned to hang vertically downward so as to not protrude into the opening 20. Once a waste receptacle (e.g. wheelie bin) has been inserted through the opening 20 into the cage 10, the locking bar 15 can be rotated to extend horizontally across the opening 20 so as to engage and secure the second end of the locking bar 15 to the outer facing surface of the second of the in-use forward corner posts 12. For example, the locking bar 15 can be secured such that it resides below the handles 87 or a ribbed flange 88 of the waste receptacle. Where the waste receptacle is a wheelie bin 80, the locking bar 15 can locate such that the open lid 84 of the bin 80 rests thereagainst.

The flange supports 22 assist the cage 10 with absorbing the vertical forces distributed thereto from the ribbed flange 88 of the waste receptacle during the extension of the actuating arm 50 of the waste compactor 100, and the compaction of the waste within the waste receptacle by the compacting plate 60. For a wheelie bin, the ribbed flange 88 are typically the most structurally strong section of the waste receptacle. The interaction between the flange supports 22 and the ribbed flange 88 for the translation and force distribution may thus occur at the strongest section of the waste receptacle.

In addition, in instances where the compacting plate 60 comes into contact with an object having slanted, non horizontally aligned, surfaces, a portion of the vertically directed compacting force can be translated into horizontal forces. In such instances, the close conformity of the flange supports 22 around the ribbed flange 88 can assist the waste receptacle with resisting the horizontal forces.

In some forms, when inserted within cage 10, the waste receptacle is held in an elevated position above the ground surface whereby only the feet 18 of the waste compactor 100 are in contact with the ground surface. The waste materials are compacted by the compressive engagement of the waste materials between the compacting plate 60 and one or more walls of the waste receptacle. Thus, in use, when forces are applied against the waste by the actuating arm 50, the forces are distributed into, and counter acted by, the flange supports 22 of the cage 10 rather than being applied into the ground surface. The translation of forces into the flange supports 22 thus advantageously may ensure that the only forces applied to the ground surface through the feet 18 are the consistent weight of the waste compactor 100 and the weight of the waste receptacle and the contents thereof. Thus, the actuating arm 50 does not exert a force against the ground surface. The maximum allowable compacting force exerted by the actuating arm 50 and the overall stability of the waste compactor 100 are thus increased.

As would be understood by one skilled in the art, the width, depth and height of the interior cavity of the assembled cage can be re-dimensioned to suit the outer dimensions of the corresponding waste receptacle. In some forms, not shown, the framework of the cage can be adjustable so as to enable the waste compactor to be custom fit to waste receptacles within a range of sizes and shapes.

A frame 30 supports the actuating arm 50 and compacting plate 60 of the waste compactor 100 above the cage 10. The frame 30 comprises a pair of upright beams 32 that are secured to opposing sides of the cage 10 and a horizontal beam 34 that spans across and rests on top of the upright beams 32. The horizontal beam 34 and upright beams 32 can define a square arch-like framework. The upright beams 32 can be secured to an outwardly facing surface of each of the flange supports 22 and the side upper cross-bars 16′, and arranged to extend vertically upwards therefrom to a height V-V above the top of the cage 10. The height V-V of the upright beams 32 can be longer than a combined length L-L of the actuating arm 50 and compacting plate 60 below the horizontal beam 34, whereby the in-use lower compacting surface 62 of the compacting plate 60 sits above the top of the cage 10 and waste receptacle when the actuating arm 50 is in an unextended, fully retracted, configuration (e.g. see FIGS. 1B, 2B and 3A). The upright beams 32 are secured to the cage 10 intermediate the laterally extending second central axis Y-Y and the in-use forward side 11 of the cage 10. For example, the upright beams 32 can be secured to the cage 10 at approximately one third of the distance between the in-use forward side 11 and the in-use rearward side 13 of the cage 10.

The horizontal beam 34 can comprise a first member 34′ that is arranged with the plane of its wider planar surface extending horizontally across a portion of the tops of the upright beams 32. A second member 34″ is arranged alongside the first member 34′ with the plane of its wider planar surface extending substantially vertically, and perpendicularly to the first member 34′, across a portion of the tops of the upright beams 32. A box containing various electronics 38 is stored above the first member 34′, the electronics 38 being connected to the actuating arm 50. The electronics 38 comprises one or more of a power source for the actuator (e.g. a battery), wiring, limit sensors, safety relays and a controller.

The actuating arm 50 is pivotally, and substantially centrally, secured to the horizontal beam 34 by a hinge 36 that is configured to rotate towards the in-use rearward side 13 of the cage 10. A first side of the hinge 36 is secured to the rearward facing planar surface of the second member 34″ of the horizontal beam 34, and the adjoining second side of the hinge 36 is secured to a rearward facing side of the swivel beam 58 that extends across the top of the actuating arm 50 and defines a top surface of the actuating arm 50. In an untilted configuration, with the actuating arm 50 aligned with the vertical axis of the waste compactor 100 at 0 degrees of tilt, the top surface of the swivel beam 58 of the actuating arm 50 abuts the underside of the horizontal beam 34, thereby preventing the actuating arm 50 from pivotally swinging forwards about the hinge 36. The range of rotational motion of the actuating arm 50 about the hinge 36 is thus constrained by the horizontal beam 34. When the actuating arm 50 is pivoted about the hinge 36, the angle between a longitudinal axis through the actuating arm 50 and a vertical axis through the cage 10 is adjusted. For example, with reference to the Figures, the actuating arm 50 can be pivotally rotated between 0 and 180 degrees. The hinge 36 thus acts as a pivot point, allowing an operator to freely adjust the angle through which the actuating arm 50 drives the compacting plate 60.

The hinge 36 enables a user to deposit additional waste material into the waste receptacle whilst the waste receptacle is held within the interior cavity of the cage 10. The compacting plate 60 can be pivoted away from the upper rim 86 of the wheelie bin 80, rather than covering over the opening to the waste receptacle and acting as an obstacle to adding further waste material between compacting operations. Thus, instead of entirely removing the waste receptacle (e.g. wheelie bin) from the waste compactor 100, the compacting plate 60 may simply be tilted rearwards about the hinge 36 so as to provide sufficient clearance and access to the opening of the waste receptacle.

The actuating arm 50 comprises of a linear actuator 55 that is driven by a powered actuator 56, a linear rail 52 and a carriage 54. As would be understood by one skilled in the art, the powered actuator 56 can be any of a pneumatic, hydraulic, or electric powered actuator. The linear rail 52 is fixed to the underside of the swivel beam 58 so as to locate forward, in use, of the carriage 54 and linear actuator 55. A handle 40 is located below, and adjacent to, a plurality of actuation control buttons 42 at an in-use lower portion of the forward facing panel of the linear rail 52. In use, the handle 40 provides an operator with a location through which to manually grip and apply a pull or pushing force to the actuating arm 50. By positioning the handle 40 at an in-use lower portion of the linear rail 52, the operator is provided with additional mechanical advantage when pushing or pulling the lever arm defined by the pivotally hinged actuating arm 50. The location of the control buttons 42 proximal to the handle enable the operator to easily access the buttons, in order to control the actuation of the linear actuator 55 in real-time. The arrangement of the handle 40 and buttons 42 may thus facilitate improved control by an operator over the actuating arm 50 and allow the waste compactor 100 to function as a user-driven force manipulator. In a variation, not shown, the actuating arm can utilise a geared system or a crank mechanism to improve the mechanical advantage for an operator when pivoting the actuating arm about the hinged connection. In some forms, not shown, the hinge can be locked in a desired orientation, when required.

An in-use upper portion of the carriage 54 defines a protrusion that projects away from the forward facing side of the carriage 54, and is configured to freely slide within a rail track provided along the rearward facing panel of the linear rail 52. The in-use lower end of the carriage 54 is fixedly secured to an in-use upper surface of the compacting plate 60, and is supported by a plurality of diagonal beams 57, arranged in pairs on either side of the carriage 54, which extend from a lower portion of the carriage 54 towards opposing outer edges of the upper surface of the compacting plate 60.

The linear actuator 55 is positioned further rearward of the carriage 54 and is fixed between the underside of the swivel beam 58 and the upper surface of the compacting plate 60. When driven by a powered actuator 56, the arm of the linear actuator 55 is extendable or retractable between a fully retracted unextended configuration and a fully extended configuration, or to any partially extended configuration intermediate the unextended and fully extended configurations. The dual points of connection of the carriage 54 and linear actuator 55 with the compacting plate 60, in addition to the plurality of diagonal beams 57, facilitate a strong and stable structure that is able to absorb and efficiently distribute the normal resistance forces of the waste against the compacting plate 60 that counteract the compression force applied by the extension of the linear actuator 55. The carriage 54 and linear rail 52 support the linear actuator 55 along its axis of actuation, and can assist with withstanding any forces that are applied to the linear actuator 55 perpendicularly to the axis of actuation.

In addition, the side surfaces 64 of the compacting plate 60 can be slanted. This may improve the range of angles at which the actuating arm 50 can be operated within a waste receptacle. In a variation, the side and/or lower surface of the compacting plate can be curved, or substantially convex shaped. As would be understood by a person skilled in the art, the length, width, depth and shape of the compacting plate can be designed to further optimise the compacting of the waste material within the waste receptacle. For example, in some variations, the plan cross-section of the compacting plate can correspond to the plan cross-section of the waste receptacle. In some variations, the plan cross-section of the compacting plate can be between 50 and 80% of the plan cross-section of the waste receptacle so as to enable angular movement of the actuating arm within the waste receptacle. In some variations, the corners of the compacting plate can be curved or rounded.

The horizontal distance between the powered actuator 56 of the linear actuator 55 and the point of contact between the compacting plate 60 and the waste material in the waste receptacle results in a bending moment being created. The hinge 36 provides freedom of movement in a rotational pitch pivot direction (i.e. about the X-axis), whereby the bending moment are distributed away from the compacting plate 60 and linear actuator 55 and spread within the structure of the frame 30 of the waste compactor 100. In use, an operator may thus ergonomically push or pull the handle 40 in order to adjust the position of the compacting plate 60, and the angular direction of the compression force exerted by the linear actuator 55. This may assist the waste compactor 100 in better adapting the compacting action of the actuating arm 50 to effect improved compaction of any oddly positioned or shaped waste materials contained within the waste receptacle.

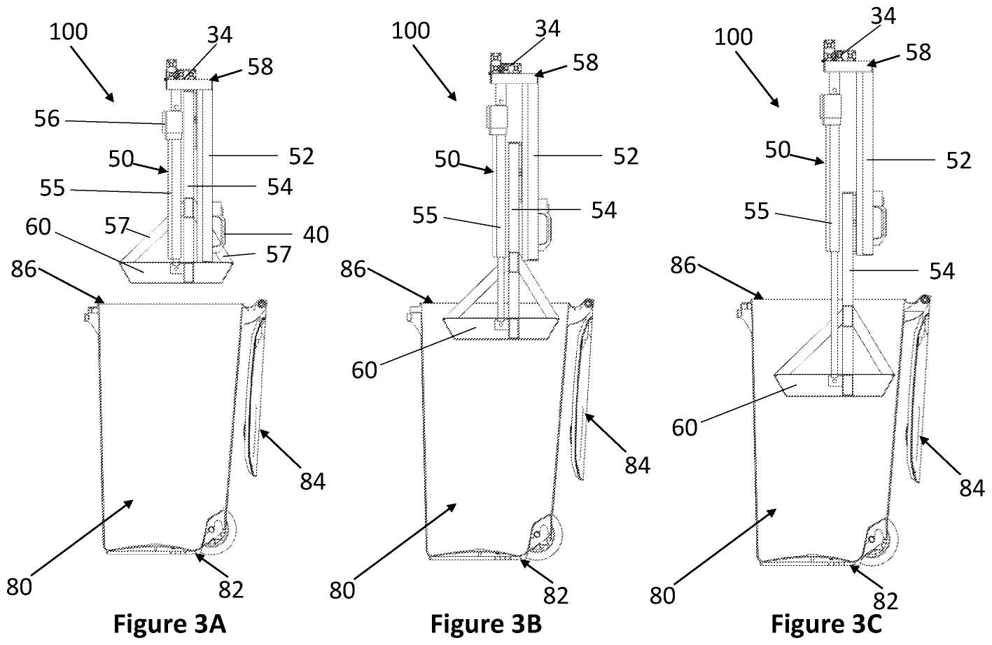

Referring to FIGS. 3A to 3C, once the waste receptacle (i.e. wheelie bin 80) has been located within the cage 10 of the waste compactor 100 with the ribbed flanges 88 supported on the flange supports 22, an operator can press a first control buttons 42 to initiate operation of the actuating arm 50. The operator can hold the handle 40 whilst the powered actuator 56 extends the linear actuator 55 and compacting plate 60, structurally supported by the carriage 54 from an unextended, fully retracted, configuration towards an extended configuration. The operator can control the operation of the powered actuator 56, temporarily pausing, stopping, or reversing the motion of the actuating arm 50 as required. The actuating arm 50 can be extended to a fully extended configuration, or extended to a configuration that is intermediate the fully retracted and fully extended configurations. In a variation, the actuating arm 50 can be operated without an operator holding the handle 40.

For example, for a wheelie bin 80 of 240 L, the actuating arm 50 can move from an untilted, unextended configuration (e.g. FIG. 3A) to an untilted extension of 225 mm (e.g. FIG. 3B), which corresponds to an intermediate configuration of approximately 50% of the fully extended configuration. The actuating arm 50 can then complete the compaction motion by extending further downwards to an untilted extension of 450 mm, which corresponds to an approximately 100% fully extended configuration (e.g. FIG. 3C).

As would be understood by a person skilled in the art, the length of the linear actuator can be varied in order to provide a smaller or greater length of extension of the actuating arm. For example, the actuating arm may be configured to extend within the waste receptacle to a height that is approximately 50% of the height H-H of the waste receptacle. In some variations, the actuating arm may be configured to extend within the waste receptacle to a height that is approximately 75% of the height H-H of the waste receptacle. In some variations, the actuating arm may be configured to extend within the waste receptacle to a height that is approximately 100% of the height H-H of the waste receptacle.

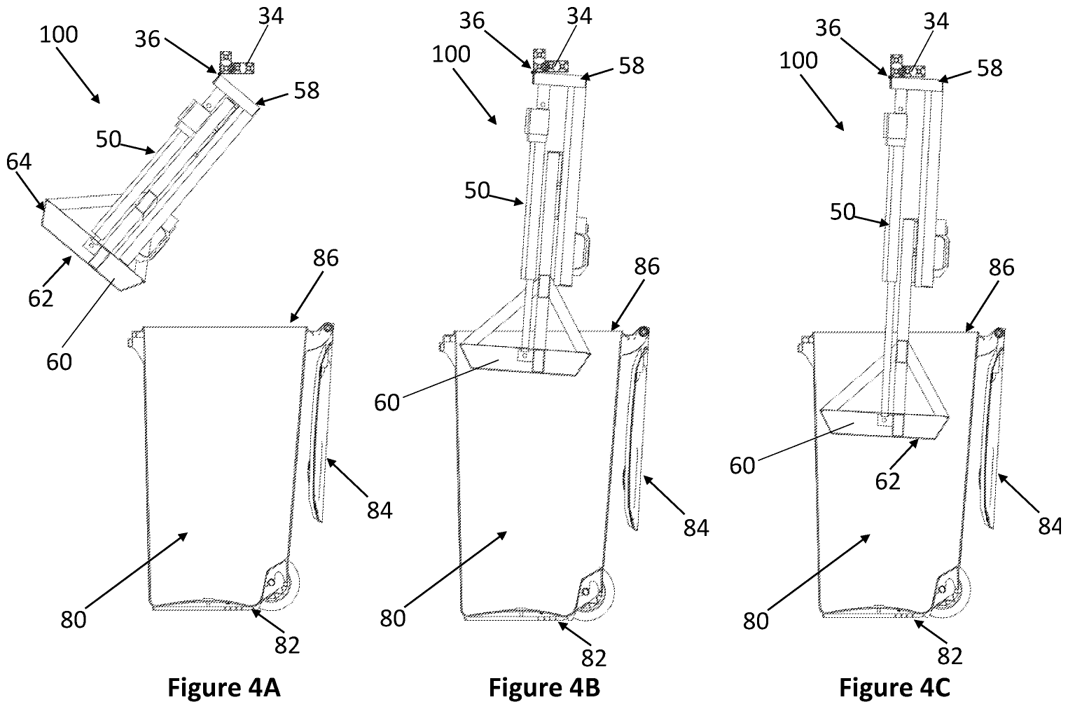

Referring to FIGS. 4A to 4C, the actuating arm 50 and compacting plate 60 can be angularly tilted rearwards, and away from the user's expected standing position, about the hinge 36 so as to provide sufficient clearance and access to the opening of the waste receptacle, or to provide a compacting force to waste material at a rearward portion of the waste receptacle, or to provide a compacting force to oddly shaped or positioned waste material within the waste receptacle. The actuating arm 50 can be angularly rotated about the hinge 36 simultaneously whilst the linear actuator 55 is expanding or contracting.

For example, for a wheelie bin 80 of 240 L, the actuating arm 50 can move from a 40 degree tilt, unextended configuration (e.g. FIG. 4A) where the actuating arm 50 is elevated above the upper rim 86 of the wheelie bin 80 and positioned rearward of the opening of the bin 80, to an 4.2 degree tilt at an extension of 225 mm (e.g. FIG. 4B), which corresponds to an intermediate configuration of approximately 50% of the fully extended configuration, and where the actuating arm 50 locates within the bin 80 proximal the upper rim 86 thereof. The actuating arm 50 can then complete the compaction motion by extending further downwards to an 3 degree tilted extension of 450 mm, which corresponds to an approximately 100% fully extended configuration (e.g. FIG. 4C) and compacts the waste material at the rearward section of the bin 80.

As would be appreciated by one skilled in the art, the disclosed assembly can be configured for use with wheelie bins ranging from 60 L to 360 L in volume.

Variations and modifications may be made to the parts previously described without departing from the spirit or ambit of the disclosure.

In the foregoing description of preferred embodiments, specific terminology has been resorted to for the sake of clarity. However, the invention is not intended to be limited to the specific terms so selected, and it is to be understood that each specific term includes all technical equivalents which operate in a similar manner to accomplish a similar technical purpose. Terms such as “front” and “rear”, “inner” and “outer”, “above”, “below”, “upper” and “lower” and the like are used as words of convenience to provide reference points and are not to be construed as limiting terms.

The reference in this specification to any prior publication (or information derived from it), or to any matter which is known, is not, and should not be taken as, an acknowledgement or admission or any form of suggestion that prior publication (or information derived from it) or known matter forms part of the common general knowledge in the field of endeavour to which this specification relates.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, invention(s) have been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

1. An assembly for compacting waste materials stored within a receptacle, the assembly comprising a frame to which a compacting arm attached, wherein the compacting arm is able to pivot relative to the frame whereby the compacting arm is able to compact the waste materials located in the receptacle by moving between an unextended configuration and an extended configuration.

2. The assembly of claim 1, wherein the compacting arm can retract from the extended configuration to the unextended configuration.

3. The assembly of claim 1, wherein the compacting arm is able to extend and/or retract to a configuration that is intermediate the unextended and extended configurations.

4. The assembly of claim 1, wherein the compacting arm pivots about a hinge attached to the frame, the compacting arm being orientated below a support on the frame.

5. The assembly of claim 4, wherein the compacting arm is able to pivot rearward of the support, away from an expected standing position of an operator.

6. The assembly of claim 1, wherein the receptacle is supported on one or more flanges provided on one or more sides of the frame.

7. The assembly of claim 1, wherein the frame comprises an upper portion and a lower portion, the lower portion providing a base for the assembly and defining a cage that is configured to receive and retain the receptacle in use, and the upper portion being supported over the lower portion with the compacting arm extending downwardly from the support so as to locate over the receptacle in use.

8-12. (canceled)

13. The assembly of claim 1, wherein the compacting arm comprises a linear actuator that operates to controllably adjust the extension thereof.

14. The assembly of claim 1, wherein the compacting arm comprises a compacting plate at an in-use lower distal end thereof.

15-18. (canceled)

19. The assembly of claim 1, wherein the receptacle is a wheelie bin.

20. A method of compacting waste materials in an assembly for compacting waste stored within a receptacle, the method comprising
locating the receptacle below a compacting arm, the compacting arm being attached to a frame, and able to pivot relative to the frame;
moving the compacting arm between an unextended configuration and an extended configuration; and
compacting the waste materials between the compacting arm and the receptacle.

21. The method of claim 20, wherein the method further comprises retracting the compacting arm from the extended configuration to the unextended configuration.

22. The method of claim 20, wherein method further comprises extending and/or retracting the compacting arm to a configuration that is intermediate the unextended and extended configurations.

23. The method of claim 20, wherein the compacting arm pivots about a hinge, the hinge attached to the frame, the compacting arm being orientated below a support on the frame.

24. The method of claim 23, wherein the compacting arm is able to pivot rearward of the support and away from an expected standing position of an operator.

25. The method of claim 20, wherein the compacting arm comprises a handle.

26. The method of claim 20, wherein the assembly comprises one or more buttons that communicate with a control system that controls the initiation and/or a cessation of operation of the compacting arm.

27-28. (canceled)

29. The method of claim 20, wherein the frame comprises an upper portion and a lower portion, the lower portion providing a base for the assembly and defining a cage that is configured to receive and retain the receptacle in use, and the upper portion being supported over the lower portion with the compacting arm extending downwardly from the support so as to locate over the receptacle in use.

30-34. (canceled)

35. The method of claim 20, wherein the compacting arm comprises a linear actuator that operates to controllably adjust the extension thereof.

36. The method of claim 20, wherein the compacting arm comprises a compacting plate at an in-use lower distal end thereof, the compacting plate being adapted to engage and compact the waste materials within the receptacle.

37-38. (canceled)
